(19) United States
(12) Patent Application Publication
(10) Pub. No.: US 2026/0336480 A1
(43) Pub. Date: Oct. 29, 2026

(54) FIXING DEVICE FOR AN ADJUSTABLE MOTOR VEHICLE SEAT

(71) Applicant: BROSE FAHRZEUGTEILE SE & CO. KOMMANDITGESELLSCHAFT, COBURG, Coburg (DE)

(72) Inventors: Matthias SÜß, Großheirath (DE); Karsten HARTLEB, Weitramsdorf (DE); Sebastian ZIBIRRE, Coburg (DE)

(21) Appl. No.: 19/120,163

(22) PCT Filed: Oct. 9, 2023
(86) PCT No.: PCT/EP2023/077818

§ 371 Date: Jun. 30, 2025

(30) Foreign Application Priority Data
Oct. 11, 2022 (DE) 10 2022 210 723.3

(51) Int. Cl. B60N 2/08; B60N 2/42

(52) U.S. Cl. CPC B60N 2/0806; B60N 2/0875; B60N 2/43

(57) ABSTRACT

A fixing device for a vehicle seat which can be adjusted along an adjustment direction, comprising at least one detent rail, which has a plurality of detent openings that are mutually spaced and are arranged one behind the other along the adjustment direction, and comprising a locking unit, which can be moved relative to the detent rail along the adjustment direction and which has a plurality of locking elements that are guided independently of one another by means of a guide device and can be brought into engagement with one of the detent openings, respectively, in a position-dependent manner, At least one of the locking elements has a notch which is arranged below the detent rail along the latching direction when the locking element is in engagement with one of the detent openings in an intended manner.

### CROSS REFERENCE TO RELATED APPLICATIONS

The present application is a U.S. National Phase of International Application No. PCT/EP2023/077818 entitled “FIXING DEVICE FOR AN ADJUSTABLE MOTOR VEHICLE SEAT,” and filed on Oct. 9, 2023. International Application No. PCT/EP 2023/077818 claims priority to German Patent Application No. 10 2022 210 723.3 filed on Oct. 11, 2022. The entire contents of each of the above-listed applications are hereby incorporated by reference for all purposes.

### BACKGROUND

The disclosure relates to a fixing device for a motor vehicle seat that is adjustable along an adjustment direction and a longitudinal guide rail means therewith.

The fact that the motor vehicle seat is intended to be adjustable along an adjustment direction does not mean, in this case, that the seat as a whole must necessarily be adjustable. Rather, this is also intended to include the adjustability of individual seat components along an adjustment direction. A respective adjustment position of the corresponding seat components can be locked by means of the fixing device.

A fixing device of this kind comprises a detent rail (extending along the adjustment direction), which comprises a plurality of detent openings that are arranged one behind the other along the adjustment direction and are mutually spaced, and a locking unit which is movable relative to the detent rail, along the adjustment direction, and comprises a plurality of locking elements, in particular in the form of locking pins, which are guided independently of one another by means of a guide device and can be brought into engagement, independently of one another (along a latching direction), with one detent opening, respectively, of the detent rail, depending on the position of the locking unit relative to the detent rail. The locking unit on the one hand and the detent rail on the other hand can for example be fastened/formed on two seat rails that are movable relative to one another. In this way, a fixing device for seat longitudinal adjustments can be achieved.

In this case, a respective detent opening of the detent rail for example comprises two transverse edges (which each extend substantially transversely to the adjustment direction) that are mutually spaced along the adjustment direction, and two longitudinal edges (which each extend substantially along the adjustment direction) that are mutually spaced perpendicularly to the adjustment direction. The longitudinal edges and the transverse edges together define a respective detent opening, the corners of which can be configured to be angular or rounded. The transverse edges are characterized in that they limit the extension of the detent openings along the adjustment direction, and the longitudinal edges limit the extension of the detent openings transversely to the adjustment direction.

The detent openings are typically dimensioned such that the detent openings have a greater extension along the adjustment direction than transversely thereto. That is to say that the longitudinal edges are typically longer than the transverse edges; however, this is not essential. In particular, the extension of the detent openings along the adjustment direction is advantageously so large that a respective locking element, viewed along the adjustment direction, can engage in an associated detent opening in a manner resting on one or the other transverse edge. Said extension of the detent openings along the adjustment direction is thus greater than the extension of a respective locking element along said direction.

The fixing device allows for delicate adjustment of the position of the locking unit relative to the detent rail using a limited number of locking elements which can engage in the mutually spaced detent openings of the detent rail.

Since the transverse edges of the detent openings are in each case formed by what is referred to as a detent strip of the detent rail, i.e. since a detent strip is formed in each case between two detent openings, a locking element that is immersed into a detent opening can be supported on one of the two detent strips or the transverse edge formed thereby. The dimensions and (periodic) spacings of the detent openings along the adjustment direction, and the (periodic) spacings between the locking elements, are for example selected according to the Nonius principle. That is to say that said spacings or periods are matched to one another such that, in each position of the locking unit relative to the detent rail, as far as possible always at least two locking elements are oriented towards the detent openings and can be immersed into these (wherein they are then supported in each case—viewed along the adjustment direction—in different directions on a respective transverse edge of the respectively associated (slot-shaped) detent opening). Thus, one locking element supports the locking unit in one possible adjustment direction, and another locking element supports it in the opposite adjustment direction. If the locking elements are lifted out of the detent openings—by means of a locking mechanism provided for this purpose—then a free adjustment of the locking unit relative to the detent rail or to the respectively associated seat components can take place.

In the design of a fixing device of this kind, it should furthermore be ensured that the extension of the detent strips along the adjustment direction should not fall below a minimum dimension, in order to ensure crash safety. Although narrow detent strips would be advantageous in the sense of a delicate adjustability of seat components, in the event of a crash significant forces can act on the detent strips, such that the detent strips must be prevented from being torn through, by corresponding dimensioning.

The longitudinal and transverse edges of a respective detent opening generally extend straight, but can—in particular in the corner regions—also extend curved (in portions).

A fixing device of the type in question and a seat rail of the type in question are known from DE 20 2005 003 626 U1 and EP 1 316 465 A1. The fixing device serves in particular for locking an adjustment position, previously approached by means of a suitable adjustment device, of two seat elements of a vehicle seat that are movable relative to one another, such as in the case of a longitudinal guide rail means for adjusting the seat position in the vehicle longitudinal direction. In this case, one rail of the longitudinal guide rail means is connected to the detent rail, and another rail to the locking unit of the fixing device. However, the fixing device can also be used for locking other adjustment devices comprising modules that are movable relative to one another, in particular longitudinally adjustable relative to one another.

The detent openings can in principle also be arranged one behind the other along a trajectory, such as a circular path. The adjustment direction then results locally in each case, from a tangent to the curve in question.

In addition to the comfort function, specifically locking of seat components (after they have been adjusted as desired) in a manner that is as simple, low-noise and reliable as possible, the fixing device is also intended to fulfil very important safety functions. In the case of a crash, the locking elements of the locking unit may not come out of engagement with the detent openings of the detent rail. Otherwise, the seat components that are locked together thereby would be able to move relative to one another in an uncontrolled manner.

Since the locking elements are usually configured to be conical at their end portions with which they can be immersed into a respective detent opening, in order to allow immersion and (play-free) locking in as far as possible any relative positions of the locking unit and detent rail, it is known from DE 299 10 720 U1 to select the angle of inclination of those particular conical end portions (also referred to hereinafter as “cone angle”) such that the locking elements cannot be pushed out or “spring out” of the respectively associated detent opening (counter to the latching direction) due to significant forces, caused by a crash, acting along the adjustment direction, when the relevant locking element rests with the flank of its conically extending end portion on a (transverse) edge of the particular detent opening. This is based on the concept that—owing to the conical configuration of the end portions—in the case of a load, i.e. in particular in the case of a force acting along the adjustment direction, a force component perpendicular thereto also arises on the locking element, which tends to lift the locking element out of the associated detent opening, which can lead to what is referred to as “springing” of the locking elements out of the respectively associated detent opening. This sound be counteracted by the conicity of the end portions on the detent rail side, i.e. their angle of inclination or cone angle, being selected such (so small) that the risk of “springing” of the locking elements due to an accident is minimized. In addition, compression springs load the locking elements with a force in the latching position. At the same time, however, it must be taken into account when selecting the conicity that a reliable engagement of the locking elements into the associated detent openings in as far as possible any adjustment positions of the locking unit with respect to the detent rail (and thus the associated seat components that are to be adjusted relative to one another) should be made possible.

Furthermore, locking elements in the form of locking pins are known from EP 1 316 465 A1, which comprise a cylindrical shaft, provided with a grooved region, for guiding the locking pins in a pin bore, wherein in each case firstly a conically tapering portion and then a further, comparatively shorter cylindrical portion adjoin the particular cylindrical shaft axially, towards the lower free end of the locking pins.

Furthermore, it should be possible for a vehicle user to lift the locking elements out of the detent openings—using an unlocking lever provided for this purpose—with little exertion of force, in order to be able to perform repositioning of a seat position. The steeper the cone angle is selected, the lower is the tendency for pushing out of the locking elements in the event of a crash, but the greater the gradation of the locking and the forces which a user has to apply for lifting out the locking elements.

### SUMMARY

The object underlying the proposed solution is of further improving a fixing device of the type mentioned at the outset, in view of the above-mentioned requirements.

This object is solved by creating a fixing device having features as described herein.

According thereto, at least one of the locking elements comprises a notch which is arranged below the detent rail along the latching direction when the locking element is in engagement with one of the detent openings in an intended manner.

While the locking element is in engagement with one of the detent openings in an intended manner, the notch can in particular be arranged below the detent rail in such a way that the notch comes into contact with one of the detent strips formed between the detent openings and hooks together therewith when the locking element enters an oblique position with respect to the latching direction by the action of external forces (e.g. in the event of a crash)—compared with its intended position in one of the detent openings—and (in the oblique position) moves upwards relative to the detent rail, counter to the latching direction, or when the locking element and/or the detent rail is deformed under the action of external (crash) forces. In contrast, such hooking of the notch with one of the detent strips is intended not to occur when the locking element is lifted out of a latching opening, counter to the latching direction, while it is oriented in an intended manner along the latching direction, i.e. in particular in the case of intended use of the fixing device in the absence of crash forces.

The proposed solution makes it possible, with simple means, to counter “springing” of a respective locking element out of the associated detent opening under the action of (crash) forces, and thus to prevent unintended unlocking of the fixing device in the event of a crash.

A respective notch can be formed by at least one groove on the locking element, which for example extends around the locking element. In this case, it is also possible for a plurality of notches, and accordingly optionally a plurality of grooves, to be provided on a respective locking element, which can in particular be arranged one behind the other along the latching direction.

In a simple manner, the locking elements can be configured as locking pins, which extend along the latching direction and are guided along said direction in a longitudinally movable manner on the fixing device. Furthermore, each of the locking elements can comprise a notch.

In the case of a spread embodiment of the locking elements such that they taper conically towards a free end, at their portion on the detent rail side that can be brought into engagement with the detent openings, wherein at least one of the locking elements is supported by the conically tapering portion on one of the detent strips, while it is in engagement with one of the detent openings, the at least one notch of a respective locking element is in particular arranged outside of the conically tapering portion, with which the locking element is supported on the detent strips, e.g. by forming the notch on the lower end region of the conically tapering portion, in the latching direction (which, when used in an intended manner, is not in contact on the detent strips in the absence of crash forces).

If the locking elements are configured, in a development, such that a cylindrical portion of the locking element also adjoins the coaxially tapering portion of a respective locking element, axially (downwards) in the latching direction, then the notch can be located or formed on the transition of the conically tapering portion to the cylindrical portion of the locking element that adjoins it downwards—or also on the cylindrical portion itself, adjoining downwards.

The notch can be of a wide range of configurations in cross-section, e.g. approximately semicircular, polygonal (optionally having rounded corners), etc.

Furthermore, it can be provided that the notch comprises a sharp-edged portion on its lower boundary along the latching direction, via which portion the notch can hook together with a detent strip on a detent opening when the locking element enters an oblique position with respect to the latching direction and moves upwards relative to the detent rail, counter to the latching direction.

In contrast, the notch is advantageously free of sharp-edged portions on its upper boundary along the latching direction, such that the notch as far as possible does not hook together with a detent strip adjoining a detent opening when the locking element moves downwards along the latching direction.

A longitudinal guide rail means for a motor vehicle seat comprising a fixing device according to the solution is implemented as described herein.

### BRIEF DESCRIPTION OF THE FIGURES

Further details and advantages of the solution will become clear from the following description of embodiments with reference to the figures.

FIG. 1 is a longitudinal section through a fixing device comprising a detent rail and a locking unit associated with the detent rail.

FIG. 2 is a schematic side view of a further embodiment of a fixing device comprising a detent rail and a locking unit associated with the detent rail.

FIG. 3 shows a development of an arrangement according to FIG. 2.

FIG. 4A is a detail of the arrangement according to FIG. 3, comprising a locking element of the locking unit which is in engagement with a detent opening of the detent rail.

FIG. 4B is the detail from FIG. 4A in a state in which the locking element comes out of engagement with the detent opening.

FIG. 5A shows a first embodiment of the end, at the detent rail side, of a locking element of the locking unit.

FIG. 5B shows a second embodiment of the end, at the detent rail side, of a locking element of the locking unit.

FIG. 5C shows a third embodiment of the end, at the detent rail side, of a locking element of the locking unit.

FIG. 5D shows a fourth embodiment of the end, at the detent rail side, of a locking element of the locking unit.

FIG. 6A shows a development of the end, at the detent rail side, of a locking element according to FIGS. 5A to 5D.

FIG. 6B shows the development according to FIG. 6A in a state in which the locking element comes into engagement with a detent strip.

### DETAILED DESCRIPTION

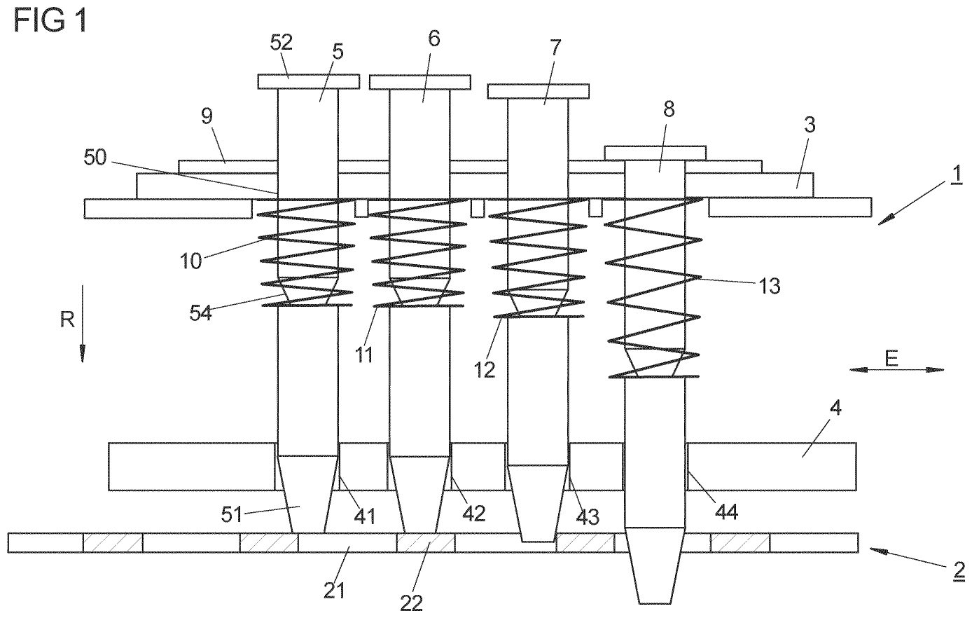

The fixing device shown in FIG. 1 comprises a locking unit 1, which is for example associated with the upper rail of a seat longitudinal adjustment means and is rigidly connected thereto, and a detent rail 2 which is correspondingly associated with the lower rail of the seat longitudinal adjustment means and is rigidly connected thereto. The detent rail 2 can be a component manufactured separately from the lower rail or a component formed integrally thereon. The detent rail 2 contains a plurality of detent openings 21 which are arranged (periodically) one behind the other along an adjustment direction E and which are separated from one another by detent strips 22.

The locking unit 1 arranged above the detent rail 2 comprises a plurality of, in the present embodiment four, locking pins 5, 6, 7, 8 which are arranged at a constant spacing from one another (along the adjustment direction E), wherein the spacing of the locking pins 5, 6, 7, 8 adjacent to the central axes is smaller, in the embodiment, than the period of the detent openings 21 and detent strips 22 of the detent rail 2. The locking pins 5-8 comprise a cylindrical shaft 50, which is closed at its upper end by a head or collar 52 and which transitions at its lower end into a conical (frustoconical) end portion 51 on the detent rail side.

The shafts 50 of the locking pins 5, 6, 7, 8 are movably guided in an (upper) bearing part 3—by means of bearing openings there—and in a (lower) guide of a guide device 4, in the latching direction R of the locking pins 5, 6, 7, 8, wherein a number of guide bores or guide channels 41, 42, 43, 44 corresponding to the number of locking pins 5, 6, 7, 8 is provided as guide means of the guide device 4, in which bores or channels the shafts 50 of the locking pins 5, 6, 7, 8 are guided (e.g. with some clearance).

Compression springs 10, 11, 12, 13 are arranged between the upper bearing part 3 and a recess 54 of the locking pins 5, 6, 7, 8 that serves as a stop, which compression springs preload the locking pins 5, 6, 7, 8, associated with the detent openings 21 of the detent rail 2, along the latching direction R, towards the detent openings 21.

An unlocking lever 9 is arranged between the upper head 52 of the locking pins 5, 6, 7, 8 and the bearing part 3 of the guide device, which lever, upon pivoting, pulls the locking pins 5-8, located in a locking position, out of the locking with the detent rail 2, counter to the latching direction R, such that the parts of the vehicle seat that are adjustable relative to one another are released for an adjustment process. In this case, the unlocking lever 9 acts on all the locking pins 5-8 together, in order to move the locking pins 5-8, located in a locking position, out of that position.

Since, in particular in the case of a precisely fitting guidance of the locking pins 5-8 in the guide bores or guide channels 41-44, canting or falling out could occur, above all if the flanks formed by the conical or frustoconical portions 51 rest on a detent strip 22 of the detent rail 2 and additional ridges are present in the guide regions, the portion of the shafts 50 of the locking pins 5 to 8 between the recess 54 and the start of the conical or frustoconical portion 51 can be provided with a thread structure, as described in DE 20 2005 003 626 U1. A thread structure of this kind not only prevents catching or canting of the locking pins 5-8 in the guide bores or guide channels 41-44 of the lower guide 4, but rather furthermore also brings about self-locking of the locking pins 5-8 in the event of a crash, when a locking pin 5-8 is latched into a detent opening 21 of the detent rail 2 or rests with a flank of its conical or frustoconical portion 51 on a detent strip 22 of the detent rail 2. The thread structure can for example be configured as a fine-pitch thread, which allows for a high degree of fitting accuracy of the locking pins 5, 6, 7, 8 in the lower guide 4 of the guide device.

In the locking state shown in FIG. 1, a locking pin 8 is located entirely immersed in a detent opening 21 and is supported on a detent strip 22, while a further locking pin 7 is supported on the inside of a detent strip 22 of the detent rail 2, with one flank of its conically extending (frustoconical) end portion 51 or an adjoining (optionally rounded) lead-in chamfer immersed in part. In contrast, the two remaining locking pins 5 and 6 rest with the end face of its conically extending end portion 51 on the upper side of two detent strips 22 owing to the spring preload.

If, for unlocking the fixing device, the unlocking lever 9 is moved counter to the latching direction R, then this firstly rests on the head 52 of one locking pin 8 and moves counter to the latching direction R and counter to the preload force of the compression spring 13 out of its engagement with the detent rail 2, until the unlocking lever 9 rests on the underside of the head 52 of the further locking pin 7 and also pulls this out of the locking position.

In the schematic illustration of FIG. 1, having a fully latched locking pin 8, a slight movement of the fixing device in the adjustment direction E is still possible, which, however can be prevented by the conically extending end portions 51 of the locking pins 5-8 in contact with the different sides of the detents 22 of the detent rail 2, in particular in that the locking pin 7 that is immersed in part into an associated detent opening 21 penetrates deeper therein.

Examples for a play-free engagement of the locking pins 5-8 into the detent rail 2, in the adjustment direction E, can furthermore be seen in DE 299 10 720 U1 and DE 20 2005 003 686 U1. In the case of this arrangement, the angle of inclination of the conically extending (frustoconical) end portions 51 of the locking pins 5-8 is selected such that the locking pins 5-8 cannot be pushed out of their associated detent openings 21 by very high forces, due to a crash, that act along the adjustment direction E, when the relevant locking pin does not have its shaft 50 inside the detent opening 21 but rather is in contact on a detent strip 22 of the detent rail 2 by the flank of the conically extending end portion 51.

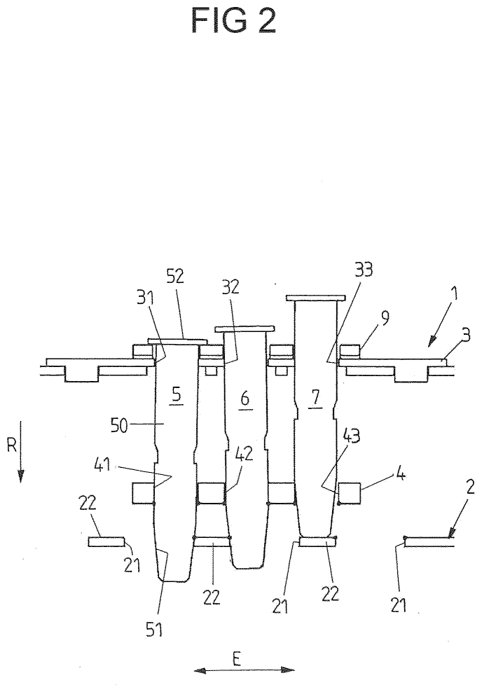

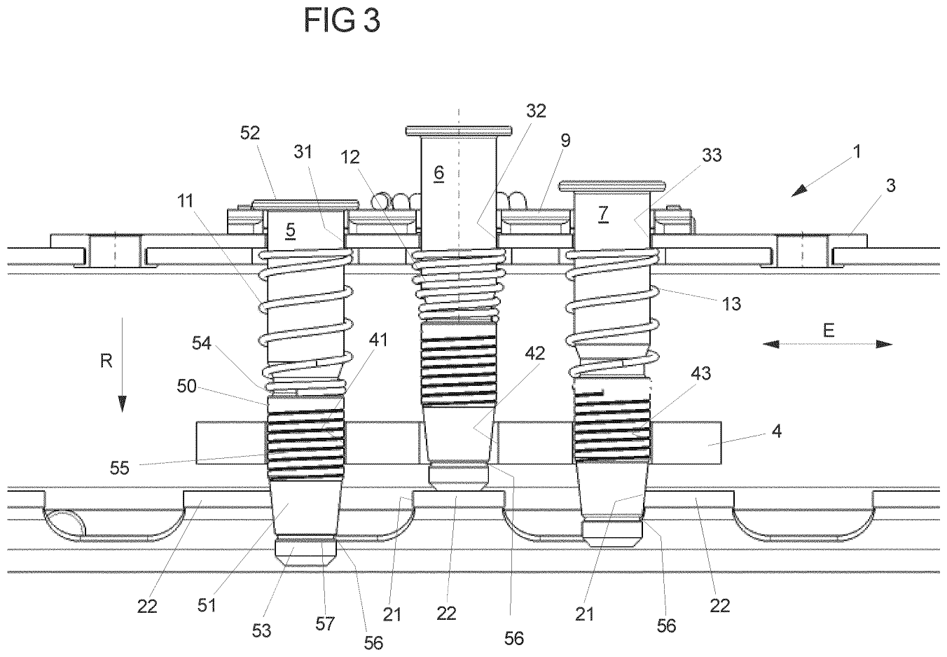

Although a reduction of the cone angle at the end portions of the locking elements, as proposed in DE 299 10 720 U1 does reduce the risk of “springing” of a locking element out of an associated detent opening under the action of crash-induced forces, at the same time this counteracts a deep immersion of the locking elements into the associated detent opening via the conical end portion. Before the way in which this problem can be overcome, according to the solution, is shown with reference to FIGS. 3 to 5D, firstly some further fundamental properties of a fixing device for an adjustable vehicle seat will be explained with reference to FIG. 2, which properties are also of significance in view of the specific embodiment according to FIGS. 3 to 5D. In this case, the embodiment shown schematically/in principle in FIG. 2 is based—in contrast to FIG. 1—on a fixing device of which the locking unit comprises three locking elements 5, 6, 7 (and not four locking elements, as in the case of FIG. 1).

In order to be able to better distinguish the individual locking elements from one another, these are provided with different reference signs 5, 6 or 7. For simplified notation, however, for the individual components of the locking elements 5, 6, 7, such as the shaft, the end portion on the detent rail side, the head, etc., in each case identical reference signs 50, 51, 52, etc. are used for all the locking elements.

For the further description, three spatial directions will be of significance each time. These are the
“Adjustment direction E”—as the direction along which two components of a vehicle seat (one provided with the detent rail and one provided with the locking unit) are adjustable relative to one another. The detent openings are located one behind the other in the adjustment direction, within an “adjustment plane”.
“Latching direction R”—a direction located approximately at right-angles to the adjustment direction R and to the adjustment plane, along which the locking elements are movable relative to the detent rail, in order to bring them into or out of engagement therewith.
“Transverse direction Q”—a direction located at right-angles to the adjustment direction E and to the latching direction R, in the adjustment plane.

The adjustment direction E, latching direction R and transverse direction Q thus form a type of three-dimensional spatial system.

According to FIG. 2, the detent openings 21 of the detent rail 2, arranged one behind the other along the adjustment direction E (and mutually spaced by strips 22) are configured with respect to their extension (length) along the adjustment direction E in such a way that a respective locking element 5, 6, 7 of the associated locking unit—viewed along the adjustment direction E—can engage in a respective detent opening 21 at different points. That is to say that the extension of the detent openings 21 along the adjustment direction E is substantially greater than the cross-sectional extension of the locking elements 5, 6, 7 along each direction E.

In the case of the fixing device, as it forms the basis of FIG. 2, in the locked state in each case two of the three locking elements 5, 6, 7 are in engagement with one of the detent openings 21 of the detent rail 2, while a further locking element is positioned on one of the detent strips 22. For this purpose, as already explained with reference to FIG. 1, the locking elements 5, 6, 7 can be preloaded resiliently towards the detent rail 2, along the latching direction R (perpendicularly to the adjustment direction E and to the transverse direction Q).

The locking elements 5, 6, 7 are in each case configured conically at their end portion 51 on the detent rail side, such that they taper towards their free end on the detent rail side. In the latched state, a respective locking element 5, 6, 7 rests, via said end portion 51 on the detent rail side, on one of the transverse edges 211, 212 of the associated detent opening 21.

The maximum possible immersion depth of the locking elements 5, 6, 7 into a respective detent opening 21 is limited by a head 52, which is arranged or formed on the free end of a respective locking element 5, 6, 7 facing away from the detent rail 2, and which forms a stop for limiting the immersion depth of the locking elements 5, 6, 7.

As is clear on the basis of FIG. 2, one of the locking elements (5) is immersed fully into an associated detent opening 21, i.e. a deeper immersion of the locking element in question is not possible, owing to the head 52 that acts as a stop. A further locking element 6 is immersed in part into an associated detent opening 21, and a third locking element 7 rests on one of the detent strips 22. In this case, the fully or partially immersed locking elements 5, 6, 7 are in each case in contact with their conically configured end portion 51 on one of the detent strips 22 delimiting the detent opening 21.

For guiding the locking elements 5, 6, 7 along the latching direction R, a guide device 4 arranged above the detent rail 2 and comprising guide openings 41, 42, 43 for the locking elements 5, 6, 7 is provided.

At its end portion facing away from the detent rail 2, the locking elements 5, 6, 7 are in each case received in bearing openings 31, 32, 33 of a bearing part 3 (for example in the form of a bearing plate or support plate). In this case, the head 52 of a respective locking element 5, 6, 7 is located in front of the side of the bearing part 3 facing away from the detent rail 2. An unlocking lever 9 acts between the heads 52 of the locking elements 5, 6, 7 and the bearing part 3, by means of which lever the locking elements 5, 6, 7 can (by tilting thereof) be lifted out of the detent openings 21, and specifically together (whereas the latching of the locking elements 5, 6, 7 into the detent openings 21 takes place independently of one another under the action of resilient forces, as has been explained with reference to FIG. 1).

The locking elements 5, 6, 7 and the associated guide device 4, as well as the bearing part 3 and the unlocking lever 9, together form the locking unit 1 of the fixing device—already described on the basis of FIG. 1 for another embodiment—which is movable or displaceable relative to the detent rail 2, along the adjustment direction E. Since the locking unit 1 on the one hand and the detent rail 2 on the other hand are connected to one of two seat components, longitudinally movable relative to one another, in each case, the latter can be locked in different relative positions by means of the fixing device formed by the locking unit 1 and the detent rail 2, wherein the locking can be overcome by means of the unlocking lever 9 for repositioning of the relative position along the adjustment direction E. In this case, the detent rail 2 can also be formed integrally on the associated seat component. The two seat components can in particular be two rails of a longitudinal guide rail means for a motor vehicle seat.

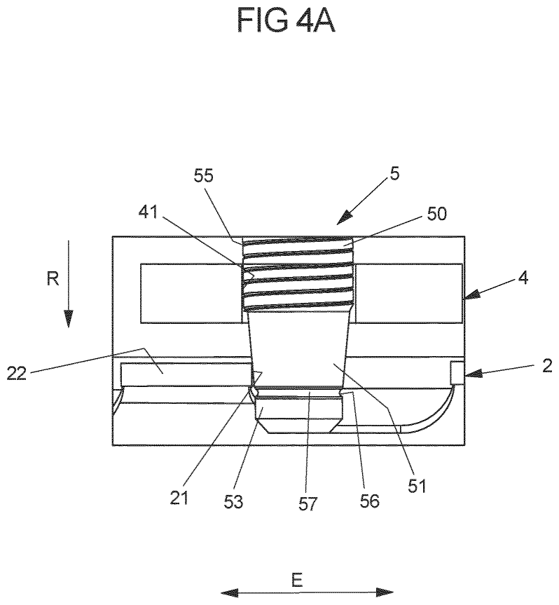

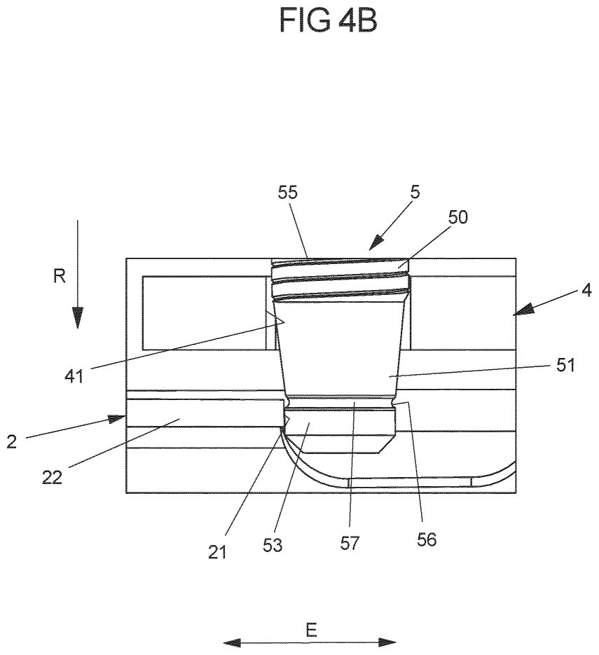

FIG. 3 shows a development of the fixing device from FIG. 2, wherein a substantial difference (in addition to the detailed illustration, including compression springs 11, 12, 13 and a thread structure 55 on the shaft 50 of the locking elements 5, 6, 7) consists in the locking elements 5, 6, 7 being provided in each case with a notch 56, specially formed here by a peripheral groove 57, which is arranged below the detent rail 2 along the latching direction R when the corresponding locking element 5, 7 is in engagement with one of the detent openings 21 in an intended manner, cf. in this respect also the enlarged detail according to FIG. 4A.

Specifically, the respective notch 56 or groove 57 is arranged below the detent rail 2, while the locking element 5, 6, 7 is in engagement with one of the detent openings 21 in an intended manner, in such a way that the notch comes into contact with one of the detent strips 22 and hooks together therewith when the locking element 5, 6, 7 enters an oblique position with respect to the latching direction R by the action of external (crash) forces—compared with its intended position in one of the detent openings 21—and moves upwards relative to the detent rail 2, counter to the latching direction R, or when the locking element 5, 6, 7 and/or the detent rail 2 are deformed under the action of external forces—alternatively or in addition to the oblique position. In the embodiment of FIG. 3, for this purpose the notch 56 is arranged outside (more precisely below) the regions of the conically tapering portion 51 of a locking element 5, 6, 7, along the latching direction, by which the locking element 5, 6, 7 is laterally supported, in an intended manner, on one of the detent strip 22, when it is latched into an associated detent opening 21, specifically e.g. on a lower end region, along the latching direction R, of the conically tapering portion 51.

In this case, according to FIG. 3 a (comparatively short) cylindrical portion 53 of the locking element 5, 6, 7 also adjoins the conically tapering portion 51 of a respective locking element 5, 6, 7, downwards in the latching direction R, i.e. towards the free end on the detent rail side, wherein the notch 56 is formed at the transition of the conically extending portion 51 to the cylindrical portion 53 of the locking element (5, 6, 7, 8) that adjoins it downwards (in the form of a peripheral groove 57).

The present case relates in particular to the behavior of the locking elements 5, 6, 7 in the case of action of crash forces, which have a force component along the adjustment direction E and/or the transverse direction Q, and thus bring about an oblique position of the locking elements 5, 6, 7 with respect to the latching direction R and/or a deformation of components of the fixing device. According to the invention, the notches 56 are intended to counteract “springing” of a respective locking element 5, 6, or 7—which is oblique and/or deformed in the event of a crash—upwards out of the associated detent opening 21 under the action of the crash forces (specifically e.g. on account of the belt forces occurring in the event of a crash, when a user of the corresponding vehicle seat is caught by the seatbelt), and thus to prevent unintended unlocking of the fixing device in the event of a crash.

In contrast, hooking of the notch 56 with one of the detent strips 22 is intended not to occur when a locking element 5, 6, 7 is lifted, in an intended manner, out of a latching opening 21 by the unlocking lever, provided for this purpose, counter to the latching direction R, while it is oriented (without a crash-related oblique position) along the latching direction, cf. FIG. 4B. In the case of use of the fixing device in an intended manner, in the absence of crash forces, no hooking should occur between the notch 56 and detent strip 22.

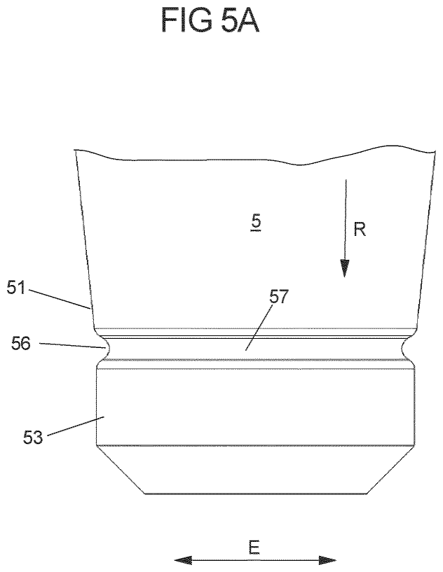

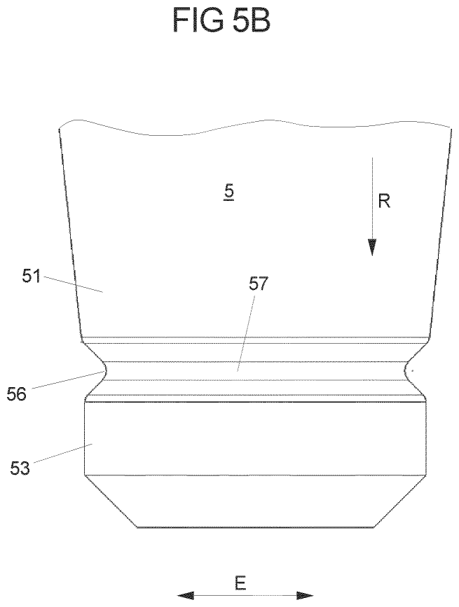

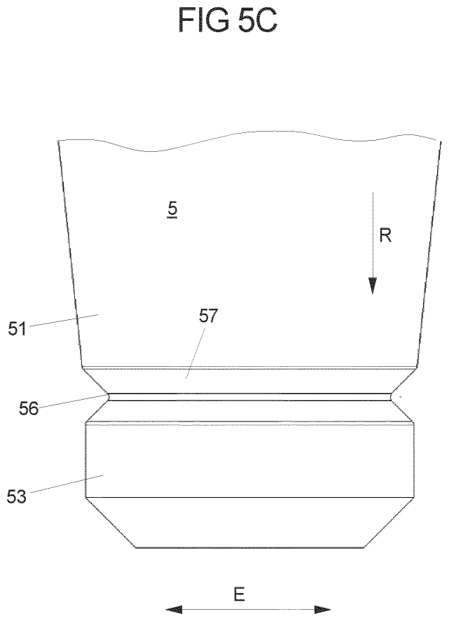

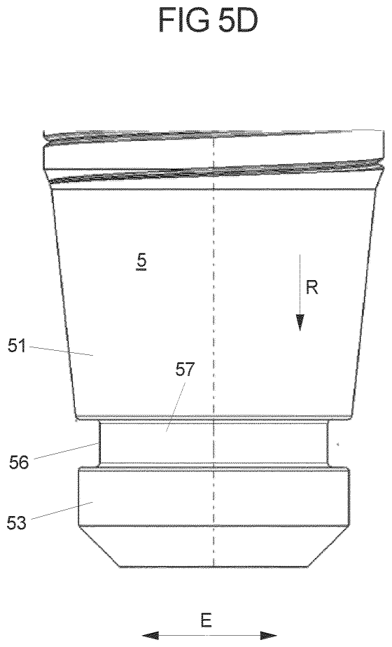

As shown in FIGS. 5A to 5D, a respective notch 56 or the corresponding groove 57 can be implemented in different configurations with respect to the cross-section, e.g. having a contour that is arcuate, in particular circular arc-shaped, in cross-section, or having a polygonal, in particular triangular or quadrilateral, cross-section, optionally having rounded corners.

The locking elements 5, 6, 7 can advantageously be configured to be round, in particular circular, in cross-section. However, a polygonal cross-section of the locking elements can also be implemented. In the first case, the conically extending end portions form a (truncated) cone, in the second case a pyramid or a truncated pyramid. In this case, a slightly oblique mounting of the locking elements may be expedient, in order to ensure a linear contact at the edges or corners of an associated detent opening.

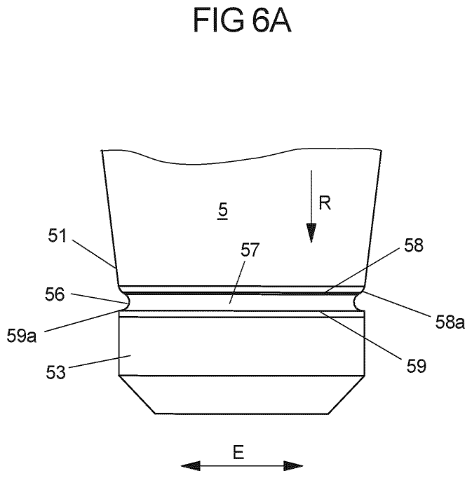

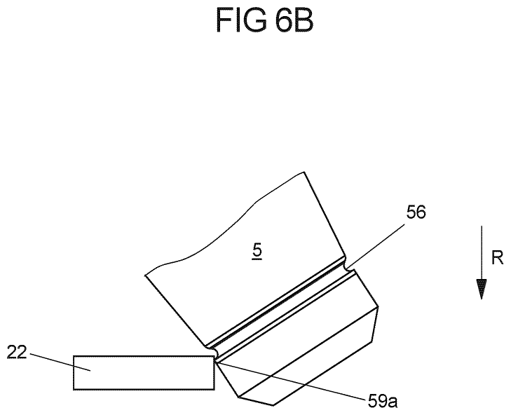

According to FIG. 6A, the notch 56 or the corresponding groove 57 comprises a sharp-edged portion 59a on its lower boundary 59 along the latching direction R, via which portion the notch 56 or groove 57 can hook together with a detent strip 22 adjoining a detent opening 21, when the locking element 5, 6, 7 enters an oblique position with respect to the latching direction R and moves upwards relative to the detent rail 2, counter to the latching direction R, cf. FIG. 6B.

In contrast, the notch 57 or groove 57 is advantageously free of sharp-edged portions on its upper boundary 58 along the latching direction R, i.e. for example provided with roundings 58a and/or chamfers, such that the notch 56 or groove 57 as far as possible does not hook together with a detent strip 22 adjoining a detent opening 21, when the locking element 5, 6, 7 moves downwards along the latching direction R.

1. A fixing device for a vehicle seat which can be adjusted along an adjustment direction, comprising
at least one detent rail, which has a plurality of detent openings that are mutually spaced and are arranged one behind the other along the adjustment direction, and
a locking unit which is movable relative to the detent rail and comprises a plurality of locking elements that are guided independently of one another by means of a guide device, are mutually spaced along the adjustment direction, and can be brought into engagement with one of the detent openings, respectively, along a latching direction,
wherein at least one of the locking elements is provided with a notch which is arranged below the detent rail along the latching direction when the locking element is in engagement with one of the detent openings in an intended manner.

2. The fixing device according to claim 1, wherein the detent openings are separated from one another by detent strips.

3. The fixing device according to claim 2, wherein the notch is arranged below the detent rail, while the locking element is in engagement with one of the detent openings, in such a way that the notch comes into contact with one of the detent strips when the locking element enters an oblique position with respect to the latching direction by the action of external forces, compared with its intended position in one of the detent openings, and moves upwards relative to the detent rail, counter to the latching direction.

4. The fixing device according to claim 2, 3, wherein the notch is arranged below the detent rail, while the locking element is in engagement with one of the detent openings, in such a way that the notch comes into contact with one of the detent strips when at least one of the locking element and the detent rail is deformed by the action of external forces.

5. The fixing device according to claim 1, wherein the notch is formed by at least one groove on the locking element.

6. The fixing device according to claim 1, wherein a groove extends around the locking element.

7. The fixing device according to claim 1, wherein a plurality of notches is formed on the locking element.

8. The fixing device according to claim 1, wherein each of the locking elements in each case comprises a notch which is arranged below the detent rail along the latching direction when the locking element is in engagement with one of the detent openings in an intended manner.

9. The fixing device according to claim 1, wherein the locking elements are configured as locking pins that are guided so as to be longitudinally movable along the latching direction.

10. The fixing device according to claim 1, wherein the locking elements taper conically towards their free end, on a portion on the detent rail side that can be brought into engagement with the detent openings in an intended manner.

11. The fixing device according to claim 2, wherein the locking elements taper conically towards their free end, on a portion on the detent rail side that can be brought into engagement with the detent openings in an intended manner, and wherein at least one of the locking elements is supported on one of the detent strips by the conically tapering portion, while it is in engagement with one of the detent openings.

12. The fixing device according to claim 11, wherein the notch of the locking element is arranged outside of the conically tapering portion by which the locking element is supported on one of the detent strips.

13. The fixing device according to claim 11, wherein the notch of the locking element is arranged outside the regions of the conically tapering portion, along the latching direction, by which portion the locking element is supported on one of the detent strips in an intended manner.

14. The fixing device according to claim 10, wherein the notch of the locking element is arranged on a lower end region of the conically tapering portion, along the latching direction.

15. The fixing device according to claim 10, wherein a cylindrical portion of the locking element also adjoins the conically tapering portion of a respective locking element downwards in the latching direction, wherein the notch is located at the transition of the conically extending portion to the cylindrical portion of the locking element that adjoins it downwards.

16. The fixing device according to claim 1, wherein the notch has, at least in part, at least one of a cross-section having an arcuate contour and/or a polygonal cross-section.

17. The fixing device according to claim 1, wherein the notch comprises a sharp-edged portion on a lower boundary along the latching direction, via which portion the notch can hook together with a detent strip adjoining a detent opening, when the locking element enters an oblique position with respect to the latching direction and moves upwards relative to the detent rail, counter to the latching direction.

18. The fixing device according to claim 1, wherein the notch is free of sharp-edged portions on its upper boundary along the latching direction.

19. A longitudinal guide rail means for a longitudinally adjustable motor vehicle seat, comprising
a first guide rail, comprising a detent rail which extends along an adjustment direction has a plurality of detent openings that are mutually spaced and are arranged one behind the other along the adjustment direction, in order to allow for locking of the motor vehicle seat in different seat longitudinal positions along the adjustment direction by engagement of at least one locking element in the detent openings of the first guide rail, and
a second guide rail that is movable relative to the first guide rail, along the adjustment direction, comprising a locking unit which comprises a plurality of locking elements that are guided independently of one another by means of a guide device, are mutually spaced along the adjustment direction, and can be brought into engagement with one of the detent openings, respectively, along a latching direction,
wherein at least one of the locking elements comprises a notch which is arranged below the detent rail along the latching direction when the locking element is in engagement with one of the detent openings in an intended manner.

20. (canceled)
